(19) United States
(12) Patent Application Publication
(10) Pub. No.: US 2006/0122296 A1
(43) Pub. Date: Jun. 8, 2006

(54) Use of silylated beta-dicarbonyl compounds as halogenated polymer stabilisers

(76) Inventors: Christian Prud'homme, Lyon (FR); Michel Gay, Villeurbanne (FR)

Correspondence Address: Jean-Louis Seugnet;Rhodia Inc Intellectual Property Department, 259 Prospect Plains Road, Cn 7500, Cranbury, NJ, 08512-7500, US

(21) Appl. No.: 10/415,575

(22) PCT Filed: Oct. 30, 2001
(86) PCT No.: PCT/FR01/03369

§ 371 Date: Aug. 6, 2003

(30) Foreign Application Priority Data
Nov. 3, 2000 (FR) 0014128

(51) Int. Cl. C08K 5/24

(52) U.S. Cl. 524/265

(57) ABSTRACT

The invention concerns the use in a stabilizing composition for halogenated polymers, of at least a silylated compound of formula: (R1)4-x-Si[O—C(R2)=CH2-C(═O)(R3)]x, wherein R1, identical or different, represent an aliphatic or aromatic radical; said radicals being selected such that the silylated compound has a boiling point higher than at least 30° C. relative to the working temperature of said polymer; R3 represents an aliphatic radical R or a radical —OR1; R2, R and R1, identical or different, represent an aliphatic radical, linear or not, comprising 1 to 10 carbon atoms, or an aromatic radical, preferably comprising 6 carbon atoms, optionally substituted by at least an aliphatic radical comprising 1 to 10 carbon atoms; x is equal to 1 or 2.

The subject of the present invention is the use of silylated β-dicarbonyl compounds as stabilizers for halogenated polymers.

More particularly, the subject of the invention is silylated compounds which are derived from β-dicarbonyl compounds whose boiling point is less than or equal to, or even slightly greater than the working temperature of the halogenated polymers.

The β-dicarbonyl compounds, such as the β-diketones or the β-keto esters, are well known stabilizers for halogenated polymers, such as polyvinyl chloride.

Acetylacetone is an example of this type of compound. Indeed, its boiling point is of the order of 140° C. This β-diketone is very effective but has the drawback of being volatile. However, in most cases, the working temperatures of the halogenated polymers are sufficiently high for acetylacetone to evaporate and escape from the polymeric composition.

In the case of β-dicarbonyl compounds whose boiling point is close to the working temperature of the halogenated polymers, difficulties are once again encountered. Indeed, in such cases, the vapor pressure of compound is very high, which is favorable to a loss of said β-dicarbonyl compound.

The object of the present invention is therefore to remedy these problems by providing a compound derived from a β-diketone or from a β-keto ester which remains as effective as the initial β-diketone or β-keto ester and which does not risk being eliminated from the polymeric composition during the working of the latter.

These aims and others are achieved by the present invention whose subject is therefore the use, in a stabilizing composition for a halogenated polymer, of at least one silylated compound of the following formula:
(R¹)₄₋ₓ—Si[O—C(R²)═CH—C(═O)(R³)]ₓ
in which formula
R¹, which are identical or not, represent an aliphatic or aromatic radical; said radicals being chosen such that the silylated compound has a boiling point at least 30° C. higher relative to the working temperature of said polymer;
R³ represents an aliphatic radical R or a radical —OR′;
R², R and R′, which are identical or not, represent a linear or nonlinear aliphatic radical comprising 1 to 10 carbon atoms, or an aromatic radical, preferably comprising 6 carbon atoms, optionally substituted with at least one aliphatic radical comprising 1 to 10 carbon atoms;
x equals 1 or 2.

It has been observed, all else being equal, and in particular the molar quantity of β-dicarbonyl compound, that the coloration stability of a halogenated polymer comprising such a silylated compound is enhanced relative to the coloration stability of a polymer comprising the same β-dicarbonyl compound which is nonsilylated.

However, other characteristics and advantages will emerge more clearly on reading the description which follows.

It should be noted that in what follows, the boiling points are those measured at room temperature (20° C.) and at atmospheric pressure (10⁵ Pa).

As was mentioned above, the stabilizing composition comprises at least one compound of formula (R¹)₄₋ₓ—Si[O—C (R²)═CH—C(═O)(R³)]ₓ.

In the above formula, as was indicated earlier, the radical R³ may represent an aliphatic radical R; in this case, the compound is a β-diketone. Alternatively, the radical R³ may represent a radical —OR′; in this case, the compound is a β-keto ester.

R², R and R′, which are identical or not, each represent a linear or nonlinear aliphatic radical comprising 1 to 10 carbon atoms, or an aromatic radical, preferably comprising 6 carbon atoms, optionally substituted with at least one aliphatic radical comprising 1 to 10 carbon atoms.

By way of example of a linear or nonlinear aliphatic radical, there may be mentioned alkyl radicals such as methyl, ethyl, propyl and its isomers, butyl and its isomers, pentyl and isomers, hexyl and isomers.

As an aromatic radical, there may be mentioned in particular benzyl, phenyl, toluyl and xylyl.

It should be noted that said radicals are more particularly chosen so that the β-diketone (or β-keto ester) from which the silylated compound is derived, has a boiling point such that the difference between the working temperature of said halogenated polymer and the boiling point of said β-diketone (or of said β-keto ester) is less than 30° C. It is specified that the difference between these two temperatures may be positive or negative.

Advantageously, the radical R or the radical R′ represents an aliphatic radical, preferably an alkyl radical, comprising 1 to 10 carbon atoms.

According to a preferred embodiment of the invention, the radical R³ represents an aliphatic radical R as defined above.

As for the radicals R¹, which are identical or not, they are first of all chosen so that the silylated compound has a boiling point at least 30° C. higher relative to the working temperature of said polymer. Preferably, the boiling point is higher by at least 60° C., and still more advantageously by at least 80° C.

More precisely, these radicals represent an alkyl radical comprising 1 to 10 carbon atoms, or an aromatic radical comprising 6 carbon atoms, optionally substituted with at least one alkyl radical comprising 1 to 10 carbon atoms.

By way of example, the radicals R¹, which are identical or not, are chosen from methyl, ethyl, propyl and isomers, butyl and isomers, pentyl and isomers, hexyl and isomers, benzyl, phenyl, toluyl and xylyl radicals.

Finally, the silylated compounds may comprise one molecule of β-dicarbonyl compound (x=1) or two molecules of β-dicarbonyl compound (x=2).

It should be noted that the stabilizing composition may comprise one or more silylated compounds.

More particularly, the silylated compound entering into the stabilizing composition is present in an amount of between 0.05 and 2 parts by weight per 100 parts by weight of halogenated polymer. Preferably, the amount of silylated compound is between 0.05 and 1 part by weight relative to the same reference.

The silylated compounds may be obtained by any means known to persons skilled in the art.

By way of example, it is possible to react the β-dicarbonyl compound with the halosilane, optionally in the presence of an amino base (such as pyridine, imidazole), preferably in a stoichiometric quantity, because its role is to capture the hydrochloric acid formed.

This reaction generally takes place in the presence of a solvent chosen from ethers, aliphatic hydrocarbons (pentane, for example), or aromatic hydrocarbons (toluene, for example).

Furthermore, the halosilane and the β-dicarbonyl compound are advantageously used in a stoichiometric quantity, even in the presence of a slight excess of halosilane.

It is likewise recommended to carry out the reaction under an anhydrous atmosphere, such as rare gases (such as argon) and nitrogen, inter alia.

The reaction temperature may be easily determined by persons skilled in the art. Purely by way of illustration, the temperature varies between 20 and 100° C.

Once the reaction is complete, the silylated compound is separated from the reaction mixture, for example by distillation.

The stabilizing compound used for stabilizing halogenated polymers may comprise, in addition, at least one organometallic stabilizer comprising a metal chosen from groups IIA, IIB and IIIB of the Periodic Table of Elements (which appeared in the bulletin de la société chimique de France—January 1966). In particular, calcium, barium, zinc, cadmium, lead and tin are suitable, as well as combinations thereof. Preferably, the stabilizer comprises at least calcium, zinc or mixtures thereof.

The organometallic stabilizers are chosen more particularly from the metal salts of saturated or unsaturated aliphatic, aromatic or nonaromatic carboxylic acids optionally carrying one or more hydroxyl groups, or alternatively chosen from aromatic or nonaromatic alcoholates.

By way of examples of such compounds, there may be mentioned salts of maleic, acetic, diacetic, propionic, hexanoic, 2-ethylhexanoic, decanoic, undecanoic, lauric, myristic, palmitic, stearic, oleic, ricinoleic, behenic (docosanoic), hydroxystearic, hydroxyundecanoic, benzoic, phenylacetic, para-tert-butylbenzoic and salicylic acids, phenolates, alcoholates derived from naphthol or phenols substituted with one or more alkyl radicals, such as nonylphenols.

In the case of a zinc-based organometallic stabilizer, the stabilizing composition advantageously has a content of organometallic stabilizer of between 10 and 200 ppm, expressed as metal, relative to the weight of halogenated polymer. Preferably, the content of organometallic stabilizer is between 30 and 150 ppm, expressed as metal, relative to the weight of halogenated polymer. It should be noted that these ranges more particularly represent the total content of this metal present in the stabilizing composition.

In the case of an organometallic stabilizer comprising calcium, the composition advantageously has a content of organometallic stabilizer of between 30 and 600 ppm, expressed as metal, relative to the weight of halogenated polymer. Here again, it should be noted that these values more particularly represent the total content of this metal present in the stabilizing composition.

The stabilizing composition may comprise other conventional additives in the field, or may be used with conventional additives in the field.

By way of additives which may be envisaged, there may be mentioned free or chelated β-diketones whose boiling point is at least 30° C., more particularly at least 60° C., preferably at least 80° C., higher relative to the working temperature of said halogenated polymer.

By way of example of such compounds, there may be mentioned most particularly octanoylbenzoyl-methane, stearoylbenzoylmethane, dibenzoylmethane or alternatively acetylbenzoylmethane.

For the compounds provided in the form of a chelate, and therefore combined with a metal, the latter is usually zinc, calcium, aluminum, magnesium or lanthanum; calcium and zinc being preferred.

Furthermore, these products may be used in purified or unpurified form.

The following commercial products may be advantageously used: Rhodiastab 50®, Rhodiastab X5®, Rhodiastab 83®, Rhodiastab X2®, Rhodiastab X7®, Rhodiastab X9®, marketed by Rhodia Chimie.

The free or chelated β-diketone content is usually between 0.05 and 1 part by weight per 100 parts by weight of halogenated polymer. It should be noted that if a β-diketone chelated with calcium or zinc is present, the content of this chelated compound is such that the total zinc or calcium content is in the ranges indicated above.

The polyols comprising 2 to 32 carbon atoms and having two to nine hydroxyl groups, may also be used as additives in this field.

Among these compounds, there may be mentioned C₃-C₃₀ diols such as propylene glycol, butanediol, hexanediol, dodecanediol, neopentyl glycol, polyols such as trimethylolpropane, pentaerythritol, dipentaerythritol, tripentaerythritol, xylitol, mannitol, sorbitol, glycerine and mixtures of oligomers of glycerine having a degree of polymerization of 2 to 10.

Another family of polyols which may be suitably used consists of partially acetylated polyvinyl alcohols.

It is likewise possible to use hydroxylated compounds comprising isocyanurate groups, alone or in combination with the abovementioned polyols, such as for example tris(2-hydroxyethyl) isocyanurate.

The quantity of polyol used is generally between 0.05 and 5 parts by weight per 100 parts by weight of polymer. More particularly, it is less than 2 parts by weight per 100 parts by weight of halogenated polymer.

It is possible to optionally incorporate into the formulation, or to use with the latter, compounds of the organic phosphite type, such as for example trialkyl, aryl, triaryl, dialkylaryl or diarylalkyl phosphites, for which the term alkyl denotes hydrocarbon groups of C₈-C₂₂ monoalcohols or polyols, and the term aryl denotes aromatic groups of phenol or of phenol substituted with C₆-C₁₂ alkyl groups.

It is similarly possible to use inorganic phosphites such as calcium phosphites. For example, compounds of the Ca(HPO₃).(H₂O) type and phosphite—hydroxy—aluminum—calcium complexes may be used.

The content of additive of this type is usually between 0.1 and 2 parts by weight per 100 parts by weight of halogenated polymer.

The stabilizing composition may comprise, or may be used with, compounds of the epoxide type. These compounds are generally chosen from epoxidized polyglycerides, or epoxidized fatty acid esters, such as epoxidized linseed, soybean or fish oils.

The quantity of compounds of this type usually varies between 0.5 and 10 parts by weight per 100 parts by weight of halogenated polymer.

Among the conventional additives, there may likewise be mentioned aluminum and/or magnesium sulfates and/or carbonates, of the hydrotalcite type in particular. They are more particularly compounds of formula Mg₁₋ₓAlₓ(OH)₂Aⁿ⁻_{x/n}-mH₂O, in which x is between 0 excluded and 0.5, Aⁿ⁻ represents an anion such as carbonate in particular, n varies from 1 to 3 and m is positive. It should be noted that it is possible to use products of this type which have undergone a surface treatment with an organic compound. There would likewise be no departure from the context of the present invention by using a product of the hydrotalcite type doped with zinc, which has optionally undergone a surface treatment with an organic compound. Among the products of this type, there may be mentioned most particularly Alcamizer® 4 (marketed by the company Kyowa).

It is also possible to use essentially amorphous compounds of formula (MgO)_{y}, Al₂O₃, (CO₂)ₓ, (H₂O)_{z}, in which x, y and z verify the following inequalities: 0<x≦0.7; 0<y≦1.7 and z≧3. These compounds are in particular described in patent application EP 509 864. Moreover, the compounds called catoites of formula Ca₃Al₂(OH)₁₂ or Ca₃Al₂(SiO)₄(OH)₁₂ may be used.

It is likewise possible to use additives of the synthetic, crystalline alkali metal aluminosilicate type, having a water content of between 13 and 25% by weight, having the composition 0.7-1M₂O.Al₂O₃.1.3-2.4SiO₂ in which M represents an alkali metal such as in particular sodium. Zeolites of the NaA type, as described in patent U.S. Pat. No. 4,590,233, are particularly suitable.

The content of this type of compound generally varies between 0.1 and 5 parts by weight per 100 parts by weight of halogenated polymer.

The compositions may also comprise (or may be used with) titanium dioxide, preferably in rutile form, optionally having undergone a surface treatment, preferably of the mineral type.

Generally, the particle size of the titanium dioxide is between 0.1 and 0.5 μm.

Among the suitable titanium dioxides, there may be mentioned, inter alia, the titanium dioxides Rhoditan® RL18, Rhoditan® RL90, marketed by Rhodia Chimie, the titanium dioxides KRONOS 2081® and 2220® marketed by Kronos.

The formulations based on halogenated polymers may likewise comprise other white or colored pigments. Among the colored pigments, there may be mentioned in particular cerium sulfide.

It should be noted that the quantity of pigment introduced into the formulation varies within wide limits and depends in particular on the coloring power of the pigment and on the final coloration desired. However, by way of example, the quantity of pigment may vary from 0.1 to 20 parts by weight per 100 parts by weight of halogenated polymer, preferably from 0.5 to 15 parts by weight relative to the same reference.

Other conventional additives may make up the formulation, according to the application for which it is intended.

As a general rule, the formulation may comprise phenolic antioxidants, anti-UV agents such as 2-hydroxybenzophenones, 2-hydroxybenzotriazoles or sterically hindered amines, usually known by the term Hals.

The content of this type of additive generally varies between 0.05 and 3 parts by weight per 100 parts by weight of halogenated polymer.

If necessary, it is also possible to use lubricants which will facilitate the use, chosen in particular from glycerol monostearates or alternatively propylene glycol, fatty acids or esters thereof, the montanate waxes, the polyethylene waxes or their oxidized derivatives, paraffins, metal soaps or functionalized polymethylsiloxane oils such as for example γ-hydroxypropylenated oils.

The quantity of lubricant entering into the formulation based on a halogenated polymer generally varies between 0.05 and 2 parts by weight per 100 parts by weight of halogenated polymer.

It is also possible to use plasticizers chosen from alkyl phthalates. The compounds most generally used are chosen from di(2-ethylhexyl) phthalate, esters of linear C₆-C₁₂ diacids, trimellitate or alternatively phosphate esters.

The quantity of plasticizer used in the formulations varies within a broad range, according to the desired rigid or supple character. As a guide, the content varies from 0 to 100 parts by weight per 100 parts by weight of halogenated polymer.

As regards the halogenated polymers which may be stabilized by the composition comprising at least one silylated compound, the latter are more especially chlorinated polymers.

The invention is particularly well suited for stabilizing formulations based on polyvinyl chloride (PVC).

The expression polyvinyl chloride is understood to mean compositions in which the polymer is a homopolymer of vinyl chloride. The homopolymer may be chemically modified, for example by chlorination.

Numerous copolymers of vinyl chloride may also be stabilized using the composition according to the invention. They are in particular polymers obtained by copolymerization of vinyl chloride with monomers having an ethylenically polymerizable bond, such as for example vinyl acetate, vinylidene chloride; maleic and fumaric acids or esters thereof; olefins such as ethylene, propylene, hexene; acrylic or methacrylic esters; styrene; vinyl ethers, such as vinyl dodecyl ether.

Usually, the copolymers contain at least 50% by weight of vinyl chloride units and preferably at least 80% by weight of such units.

PVC alone or as a mixture with other polymers is the chlorinated polymer most widely used in the stabilized formulations according to the invention.

In general, any type of polyvinyl chloride is suitable, regardless of its mode of preparation. Thus, the polymers obtained for example using processes in bulk, in suspension or in emulsion may be stabilized using the composition according to the invention, regardless of the intrinsic viscosity of the polymer.

The working of the halogenated polymer comprising the stabilizing composition may be carried out by any means known to persons skilled in the art.

It is thus possible to incorporate the various constituents into the polymer individually or alternatively after having prepared beforehand a mixture of several of these constituents.

Conventional methods of incorporation are perfectly suitable for producing the formulation based on PVC.

Thus, and solely as a guide, it is possible to carry out this operation in a mixer provided with a system of paddles and counter-paddles operating at high speed.

Generally, the mixing operation is performed at a temperature of less than 130° C.

Once the mixture has been prepared, the composition is worked according to the customary methods in the field such as injection, extrusion-blowing, extrusion, calendering or alternatively molding by rotation.

The temperature at which the working is performed varies in general from 150 to 220° C.

1. The use, in a stabilizing composition for halogenated polymers, of at least one silylated compound of the following formula:
(R¹)₄₋ₓ—Si[O—C(R²)═CH—C(═O)(R³)]ₓ
in which formula
R¹, which are identical or not, represent an aliphatic or aromatic radical; said radicals being chosen such that the silylated compound has a boiling point at least 30° C. higher relative to the working temperature of said polymer;
R³ represents an aliphatic radical R or a radical —OR′;
R², R and R′, which are identical or not, represent a linear or nonlinear aliphatic radical comprising 1 to 10 carbon atoms, or an aromatic radical, preferably comprising 6 carbon atoms, optionally substituted with at least one aliphatic radical comprising 1 to 10 carbon atoms;
x equals 1 or 2.

2. The use as claimed in the preceding claim, characterized in that the radical R¹ is an alkyl radical comprising 1 to 10 carbon atoms, or an aromatic radical comprising 6 carbon atoms, optionally substituted with at least one alkyl radical comprising 1 to 10 carbon atoms.

3. The use as claimed in claim 2, characterized in that R¹, which are identical or not, represent a methyl, ethyl, propyl, isopropyl, butyl and isomers, pentyl and isomers, hexyl and isomers, phenyl, toluyl or xylyl radical.

4. The use as claimed in one of the preceding claims, characterized in that R², R or R′, which are identical or not, each represent an alkyl radical comprising 1 to 10 carbon atoms.

5. The use as claimed in one of the preceding claims, characterized in that R³ represents a radical R chosen from alkyls comprising 1 to 10 carbon atoms.

6. The use as claimed in one of the preceding claims, characterized in that the content of silylated compound is between 0.05 and 2 parts by weight per 100 parts by weight of halogenated polymer, preferably between 0.05 and 1 part by weight relative to the same reference.

7. The use as claimed in one of the preceding claims, characterized in that the composition comprises at least one organometallic stabilizer comprising a metal chosen from groups IIA, IIB and IIIB of the Periodic Table of Elements, preferably calcium, zinc or a combination thereof.

8. The use as claimed in claim 7, characterized in that the organometallic stabilizer is chosen from the metal salts of saturated or unsaturated aliphatic, aromatic or nonaromatic carboxylic acids optionally carrying one or more hydroxyl groups, or aromatic or nonaromatic alcoholates.

9. The use as claimed in either of claims 7 and 8, characterized in that the stabilizing composition has a content of zinc-based organometallic stabilizer of between 10 and 200 ppm, preferably between 30 and 150 ppm, expressed as metal, relative to the weight of halogenated polymer; this content representing the total quantity of this metal in the stabilizing composition.

10. The use as claimed in either of claims 7 and 8, characterized in that the stabilizing composition has a content of calcium-based organometallic stabilizer of between 30 and 600 ppm, expressed as metal, relative to the weight of halogenated polymer; this content representing the total quantity of this metal in the stabilizing composition.
R¹, which are identical or different, represent an aliphatic or aromatic radical; said radicals being chosen such that the silylated compound has a boiling point at least 30° C. higher relative to the working temperature of said polymer;
R³ represents an aliphatic radical R or a radical —OR′;
R², R and R′, which are identical or different, represent a linear or nonlinear aliphatic radical comprising 1 to 10 carbon atoms, or an aromatic radical, optionally substituted with at least one aliphatic radical comprising 1 to 10 carbon atoms; and
x equals 1 or 2.

12. The stabilizing composition as claimed in claim 11, wherein the radical R¹ is an alkyl radical comprising 1 to 10 carbon atoms, or an aromatic radical comprising 6 carbon atoms, optionally substituted with at least one alkyl radical comprising 1 to 10 carbon atoms.

13. The stabilizing composition as claimed in claim 12, wherein R¹ represent a methyl, ethyl, propyl, isopropyl, butyl, butyl isomers, pentyl, pentyl isomers, hexyl, hexyl isomers, phenyl, toluyl or xylyl radical.

14. The stabilizing composition as claimed in claim 1 1, wherein R², R or R¹, which are identical or different, each represent an alkyl radical comprising 1 to 10 carbon atoms.

15. The stabilizing composition as claimed in claim 11, wherein R³ represents a radical R being an alkyl comprising 1 to 10 carbon atoms.

16. The stabilizing composition as claimed in claim 11, wherein the content of silylated compound is between 0.05 and 2 parts by weight per 100 parts by weight of halogenated polymer.

17. The stabilizing composition as claimed in claim 16, wherein the content is between 0.05 and 1 part by weight.

18. The stabilizing composition as claimed in claim 11, further comprising at least one organometallic stabilizer comprising a metal of groups IIA, IIB or IIIB of the Periodic Table of Elements.

19. The stabilizing composition as claimed in claim 18, wherein said metal is calcium, zinc or a combination thereof.

20. The stabilizing composition as claimed in claim 18, wherein the organometallic stabilizer is a metal salt of saturated aliphatic acid, unsaturated aliphatic acid, aromatic carboxylic acid, nonaromatic carboxylic acid, optionally carrying one or more hydroxyl groups, aromatic alcoholate or nonaromatic alcoholate.

21. The stabilizing composition as claimed claim 19, wherein the stabilizing composition has a content of zinc-based organometallic stabilizer of between 10 and 200 ppm, expressed as metal, relative to the weight of halogenated polymer; this content representing the total quantity of this metal in the stabilizing composition.

22. The stabilizing composition as claimed in claim 19, wherein the stabilizing composition has a content of calcium-based organometallic stabilizer of between 30 and 600 ppm, expressed as metal, relative to the weight of halogenated
